(19) United States
(12) Patent Application Publication
(10) Pub. No.: US 2023/0283967 A1
(43) Pub. Date: Sep. 7, 2023

(54) BONE CONDUCTION AND AIR CONDUCTION HEARING AID SWITCHING DEVICE AND METHOD THEREOF

(71) Applicant: AWNT LIMITED, New Taipei City (TW)

(72) Inventor: YI-CHANG LIU, New Taipei City (TW)

(73) Assignee: AWNT LIMITED, New Taipei City (TW)

(21) Appl. No.: 18/115,377

(22) Filed: Feb. 28, 2023

(30) Foreign Application Priority Data
Mar. 3, 2022 (TW) 111107664

(51) Int. Cl. H04R 25/00

(52) U.S. Cl. CPC H04R 25/43; H04R 25/606; H04R 2460/13

(57) ABSTRACT

The present disclosure relates a bone conduction and air conduction hearing aid switching device that utilizes a sound receiving module to receive a sound signal from an outer environment, and a switching module to activate a bone conduction hearing aid module or air conduction hearing aid module by executing a detection program. When the bone conduction hearing aid module is activated, the sound signal from the sound receiving module is input to execute a bone conduction processing program based on the sound signal, or when the air conduction hearing aid module is activated, the sound signal from the sound receiving module is input to execute an air conduction processing program based on the sound signal. Accordingly, a hearing aid with a bone conduction hearing aid system and an air conduction hearing aid system is provided, so as to correspondingly implement a bone conduction hearing aid system or an air conduction hearing aid system based on a need of the user, and increasing the convenience of the user thereby.

### CROSS-REFERENCE TO RELATED APPLICATION

This application claims the benefit of Taiwan Patent Application No. 111107664, filed on Mar. 3, 2022, in the Taiwan Intellectual Property Office, the disclosure of which is incorporated herein in its entirety by reference.

### BACKGROUND

### 1. Field of the Invention

The present disclosure generally relates to the technical field of hearing aids, in particular to a bone conduction and air conduction hearing aid switching device and method thereof that can provide bone conduction and air conduction hearing aid systems.

### 2. Description of the Related Art

In the process of human aging, the functions of various organs will gradually degenerate. Therefore, in order to improve the problem that people cannot clearly hear external sounds due to hearing degeneration, a hearing aid device is used to be attached to the human ears, and through processes such as noise removal or amplification, the external sound is output to the ear, so that people can clearly hear the external sound.

However, although hearing aids can help people with hearing disabilities improve their hearing impairment and thus improve their ability to communicate with others, since the types of hearing aids required by different hearing-impaired people are different, and different types of hearing aids also possess different problems in use, it is actually difficult to meet all the needs of a hearing-impaired person using only a single type of hearing aid.

As such, there is an urgent need for a hearing aid device that can switch between different hearing aid systems for the convenience of users, and to improve the existing problems of the prior art.

### SUMMARY

Therefore, it is an objective of the present disclosure to provide a bone conduction and air conduction hearing aid switching device, which utilizes a sound receiving module to receive a sound signal from the external environment, and then execute a detection program to determine whether to activate a bone conduction hearing aid module or to activate an air conduction hearing aid module. When the bone conduction hearing aid module is activated, the sound signal input by the sound receiving module is received to execute a bone conduction processing program based on the sound signal, or when the air conduction hearing aid module is activated, the sound signal input by the sound receiving module is received to execute an air conduction processing program based on the sound signal. Accordingly, a hearing aid with a bone conduction hearing aid system and an air conduction hearing aid system is provided, so as to implement a bone conduction hearing aid system or an air conduction hearing aid system according to user's needs, thereby increasing user convenience.

To achieve the foregoing objective, the present disclosure provides a bone conduction and air conduction hearing aid switching device, including a sound receiving module which receives a sound signal from the external environment; a bone conduction hearing aid module connected to the sound receiving module, the bone conduction hearing aid module receives the sound signal input by the sound receiving module, and the bone conduction hearing aid module executes a bone conduction processing program based on the sound signal; an air conduction hearing aid module connected to the sound receiving module, the air conduction hearing aid module receives the sound signal input by the sound receiving module, and the air conduction hearing aid module executes an air conduction processing program based on the sound signal; and a switching module arranged between the sound receiving module and the bone conduction hearing aid module and between the sound receiving module and the air conduction hearing aid module, when the switching module determines that a switching condition is met, the switching module executes a detection program to generate a switching data, and activates the bone conduction hearing aid module or the air conduction hearing aid module according to the switching data, so that the bone conduction hearing aid module or the air conduction hearing aid module receives the sound signal input by the sound receiving module.

In one example embodiment, the foregoing bone conduction and air conduction hearing aid switching device further includes a bone conduction output module connected to the bone conduction hearing aid module, when the bone conduction hearing aid module executes the bone conduction processing program, the bone conduction hearing aid module generates a vibration information corresponding to a sound wave in the sound signal, and control the bone conduction output module to execute a vibration program according to the vibration information.

In another example embodiment, the foregoing bone conduction and air conduction hearing aid switching device further includes an air conduction output module connected to the air conduction hearing aid module, when the air conduction hearing aid module executes the air conduction processing program, the air conduction hearing aid module executes an amplification program on the sound signal to generate an amplified sound signal, and outputs the amplified sound signal to the air conduction output module to output the amplified sound signal through the air conduction output module.

In another example embodiment, whether the switching module determines that the switching condition is met includes any one of the following conditions or a combination of any two or more: when the hearing aid switching device is activated, the switching module determines that the switching condition is met, and when the hearing aid switching device is turned off, the switching module determines that the switching condition is not met; when the hearing aid switching device is activated, the switching module activates a timing module to calculate a time value, and when the time value calculated by the timing module meets a time switching threshold, the switching module determines that the switching condition is met; or when the hearing aid switching device detects that the bone conduction hearing aid module is connected to a bone conduction output module or the air conduction hearing aid module is connected to an air conduction output module, the switching module determines that the switching condition is met.

In another example embodiment, when the bone conduction hearing aid module is connected with a bone conduction output module, the switching module reads a bone conduction electrical parameter of the bone conduction output module, and generates the switching data according to the bone conduction electrical parameter to activate the bone conduction hearing aid module according to the switching data; or when the air conduction hearing aid module is connected with an air conduction output module, the switching module reads an air conduction electrical parameter of the air conduction output module, and generates the switching data according to the air conduction electrical parameter to activate the air conduction hearing aid module according to the switching data.

In another example embodiment, when the bone conduction hearing aid module is connected with a bone conduction output module, and the air conduction hearing aid module is connected with an air conduction output module, the switching module executes the detection program to generate an environmental data correspondingly, and when the switching module determines that the environmental data is lower than a switching threshold and the bone conduction hearing aid module is in an activated state, or that the environmental data is higher than the switching threshold and the air conduction hearing aid module is in an activated state, the switching module generates the switching data.

In another example embodiment, the switching module receives the sound signal, and executes the detection program according to the sound signal to detect an environmental noise in the sound signal, and the switching module generates the environmental data according to the environmental noise.

In another example embodiment, when the sound signal includes the environmental noise and a user sound source, the switching module separates the environmental noise and the user sound source in the sound signal according to a sound feature point data, so that the switching module generates the environmental data according to the environmental noise.

In another example embodiment, when the switching module determines that a sound decibel in the environmental noise of the environmental data is lower than the switching threshold and the bone conduction hearing aid module is in an activated state, the switching module generates the switching data for switching to activate the air conduction hearing aid module, so as to activate the air conduction hearing aid module and turn off the bone conduction hearing aid module according to the switching data; or when the switching module determines that a sound decibel in the environmental noise of the environmental data is higher than the switching threshold and the air conduction hearing aid module is in an activated state, the switching module generates the switching data for switching to activate the bone conduction hearing aid module, so as to activate the bone conduction hearing aid module and turn off the air conduction hearing aid module according to the switching data.

Another objective of the present disclosure is to provide a bone conduction and air conduction hearing aid switching method, mainly by receiving a sound signal from an external environment with a sound receiving module, and executing a detection program by a switching module to determine whether to activate a bone conduction hearing aid module or to activate an air conduction hearing aid module. When the bone conduction hearing aid module is activated, the sound signal input by the sound receiving module is received to execute a bone conduction processing program based on the sound signal, or when the air conduction hearing aid module is activated, the sound signal input by the sound receiving module is received to execute an air conduction processing program based on the sound signal. This provides a hearing aid switching method that can be switched to a bone conduction hearing aid system or an air conduction hearing aid system, so that the corresponding bone conduction hearing aid system or air conduction hearing aid system can be implemented according to the needs of the user, thereby improves user convenience.

To achieve the foregoing objective, the present disclosure further provides a bone conduction and air conduction hearing aid switching method for the aforementioned bone conduction and air conduction hearing aid switching device, the method comprises: receiving a sound signal from an external environment with a sound receiving module; receiving the sound signal input by the sound receiving module through a bone conduction hearing aid module, and executing a bone conduction processing program based on the sound signal; receiving the sound signal input by the sound receiving module through an air conduction hearing aid module, and executing an air conduction processing program based on the sound signal; and when a switching module determines that a switching condition is met, the switching module executes a detection program to generate a switching data, and activates the bone conduction hearing aid module or the air conduction hearing aid module according to the switching data, so that the bone conduction hearing aid module or the air conduction hearing aid module receives the sound signal input by the sound receiving module.

The detailed structure, operating principle and effects of the inventive subject matter will now be described in more details hereinafter with reference to the accompanying drawings that show various embodiments of the invention as follows.

### BRIEF DESCRIPTION OF THE DRAWINGS

FIG. 1 is a schematic diagram of a configuration according to an example embodiment of the inventive subject matter.

FIG. 2 is a schematic diagram showing the connections of the bone conduction output module of an example embodiment.

FIG. 3 is a schematic diagram showing the connections of the air conduction output module of an example embodiment.

FIG. 4 is a schematic diagram showing the connections of the bone conduction output module and the air conduction output module of an example embodiment.

FIG. 5 is a flowchart of the steps of a method according to an example embodiment of the inventive subject matter.

### DETAILED DESCRIPTION

The advantages, features and technical methods achieved by the present disclosure will be described in more detail with reference to exemplary embodiments and accompanying drawings for ease of understanding, and the inventive subject matter can be implemented in different forms, so it should not be construed that the present disclosure is limited to the embodiments set forth herein. Rather, the embodiments provided will make the scope of this disclosure more thorough and complete to convey the inventive subject matter to those of ordinary skill in the art.

In addition, the terms “comprise” and/or “include” refer to the presence of stated features, regions, integers, steps, operations, elements and/or parts, but do not exclude the addition of one or more other stated features, regions, integers, steps, operations, elements and/or parts and/or combinations thereof.

For the convenience of understanding the content of the present disclosure, and the beneficial effects thereof, the specific embodiments presented in conjunction with the drawings are described in detail as follows:

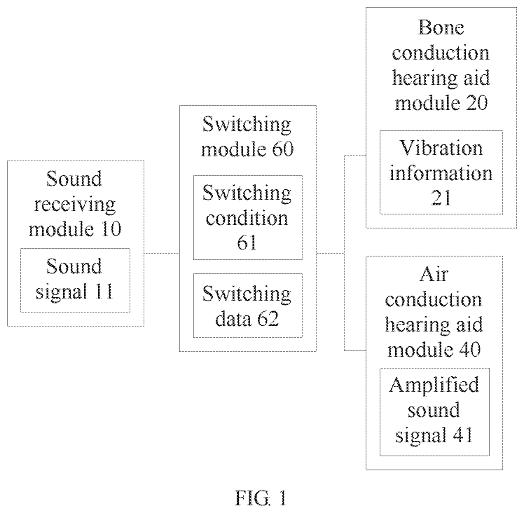

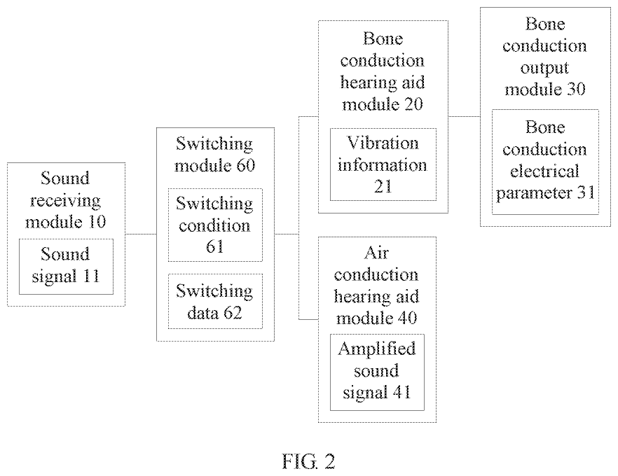

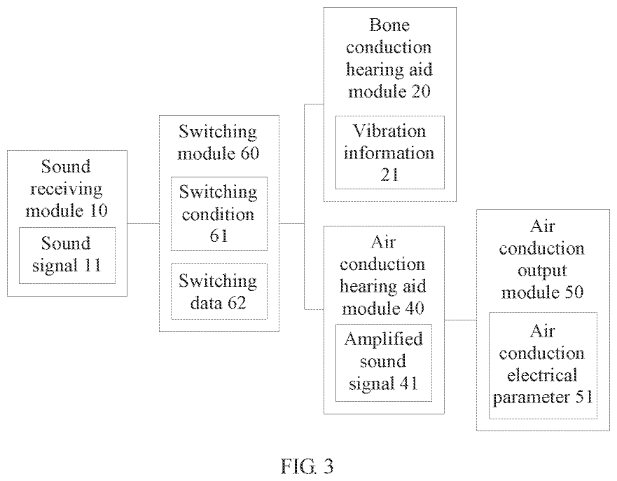

FIG. 1 to FIG. 3 show a schematic diagram of a configuration according to an example embodiment of the inventive subject matter, a schematic diagram showing the connections of the bone conduction output module of the present disclosure, and a schematic diagram showing the connections of the air conduction output module of the present disclosure. As shown in FIG. 1 to FIG. 3, one example embodiment of a hearing aid switching device includes a sound receiving module 10, a bone conduction hearing aid module 20, an air conduction hearing aid module 40 and a switching module 60. The sound receiving module 10 can specifically be a microphone or other related devices capable of receiving a sound signal 11 from the external environment.

The bone conduction hearing aid module 20 can be a system that converts the sound waves in the sound signal into vibration information, so when the bone conduction hearing aid module 20 is connected with the sound receiving module 10 to receive the sound signal 11 input by the sound receiving module 10, the bone conduction hearing aid module 20 can execute a bone conduction processing program based on the sound signal 11. Furthermore, when the bone conduction hearing aid module 20 is activated and receives the sound signal 11, the bone conduction hearing aid module 20 can execute the bone conduction processing program to generate a corresponding vibration information 21 based on the sound wave in the sound signal 11. As such, when the bone conduction hearing aid module 20 is connected with a bone conduction output module 30 (such as a vibrator), the bone conduction hearing aid module 20 can control the bone conduction output module 30 to execute a vibration program according to the vibration information 21, so that the sound signal 11 can be converted into mechanical energy correspondingly, and then the sound may be transmitted by vibrating the inner structure of the cochlea.

The air conduction hearing aid module 40 can be a system that amplifies and then outputs the sound signal, and when the air conduction hearing aid module 40 is connected with the sound receiving module 10, the air conduction hearing aid module 40 can execute an air conduction processing program based on the sound signal 11, that is, when the air conduction hearing aid module 40 is activated and receives the sound signal 11, the air conduction hearing aid module 40 can execute the air conduction processing program to generate an amplified sound signal 41 after executing an amplification program on the sound signal 11. As such, when the air conduction hearing aid module 40 is connected with an air conduction output module 50 (such as an air conduction speaker), the air conduction hearing aid module 40 can output the amplified sound signal 41 to the air conduction output module 50, so as to output the amplified sound signal 41 through the air conduction output module 50, and then the processed sound is transmitted to the inner ear through the air conduction output module 50.

However, the requirement of using the bone conduction hearing aid module 20 or the air conduction hearing aid module 40 for hearing assistance is usually selected according to the user's condition or habits, etc. For example, the bone conduction hearing aid system uses electrical signals converted into mechanical energy to vibrate the internal structure of the cochlea to transmit sound. Therefore, the bone conduction hearing aid system transmits sound directly to the auditory nerve of the inner ear through the human skull without passing through the outer ear and middle ear, while the air conduction hearing aid system uses chip algorithms to amplify and compress the sound in different frequency bands, so that the processed sound is transmitted to the inner ear through the earphone placed in the ear.

However, if the user suffers from otitis media or has a major conductive hearing loss, the air conduction hearing aid system cannot be used for auxiliary hearing aids. In addition, since the noise reduction effect of the air conduction hearing aid system is worse than that of the bone conduction hearing aid system, when the environmental noise is too loud and the sound is amplified correspondingly, it may cause the user to experience ear tremors, and since the bone conduction hearing aid system transmits sound through vibration, when the bone conduction hearing aid system is used for assisted hearing for a long time, it may cause the user to experience pain at the site wearing the bone conduction output module.

Therefore, according to the above situation, the hearing aid switching device can use the switching module 60 to switch between the bone conduction hearing aid module 20 and the air conduction hearing aid module 40. In one embodiment, the switching module 60 is arranged between the sound receiving module 10 and the bone conduction hearing aid module 20 and between the sound receiving module 10 and the air conduction hearing aid module 40, so that when the switching module 60 determines that a switching condition 61 is met, the switching module 60 executes a detection program to generate a switching data 62, and activates the bone conduction hearing aid module 20 or the air conduction hearing aid module 40 according to the switching data 62, so that the bone conduction hearing aid module 20 or the air conduction hearing aid module 40 receives the sound signal 11 input by the sound receiving module 10 accordingly.

When the switching module 60 determines whether a switching condition 61 is met, it may include any one of the following conditions or a combination of any two or more:

1. When the hearing aid switching device is activated, the switching module 60 determines that the switching condition 61 is met, and when the hearing aid switching device is turned off, the switching module 60 determines that the switching condition 61 is not met.

This is mainly because when the hearing aid switching device is activated (for example, when the power is on), the switching module 60 can directly execute the detection program to determine the currently activated system, but when the hearing aid switching device is in the off state (for example, when the power is off), the switching module 60 is in a standby or off state.

2. When the hearing aid switching device is activated, the switching module 60 activates a timing module (not shown) to calculate a time value, and when the time value calculated by the timing module meets a time switching threshold, the switching module 60 determines that the switching condition 61 is met.

Here, a timing method is used so that the hearing aid switching device can detect the relevant hearing aid module within a set period, so when the hearing aid switching device is activated, the switching module 60 can calculate the time value (for example, starting from 0, calculating in seconds) through the timing module (for example, a timer), and when the time value meets the set time switching threshold (for example, 2 hours), the switching module 60 may execute the detection program again.

3. When the hearing aid switching device detects that the bone conduction hearing aid module 20 is connected to a bone conduction output module 30 or the air conduction hearing aid module 40 is connected to an air conduction output module 50, the switching module 60 determines that the switching condition 61 is met.

In this way, when the bone conduction or air conduction output modules (30, 50) are connected, the switching module 60 can execute the detection program in real time, so as to achieve the function of switching hearing aid modules. For example, the hearing aid switching device can be provided with an access port to connect the bone conduction or air conduction output module (30, 50), and when the bone conduction output module 30 previously connected to the access port is disconnected so the air conduction hearing aid module 40 can be connected to the access port, the switching module 60 determines that the switching condition 61 is met, and then execute the detection program.

When the switching module 60 is executing the detection program to generate the switching data 62, it may include:

1. When the bone conduction hearing aid module 20 is connected with a bone conduction output module 30, the switching module 60 reads a bone conduction electrical parameter 31 of the bone conduction output module 30, and generates the switching data 62 according to the bone conduction electrical parameter 31 to activate the bone conduction hearing aid module 20 according to the switching data 62; or

2. When the air conduction hearing aid module 40 is connected with an air conduction output module 50, the switching module 60 reads an air conduction electrical parameter 51 of the air conduction output module 50, and generates the switching data 62 according to the air conduction electrical parameter 51 to activate the air conduction hearing aid module 40 according to the switching data 62.

That is, when the switching module 60 executes the detection program, it can detect the electrical parameters of the bone conduction output module 30 or the air conduction output module 50, wherein the electrical parameters may include impedance, current or power etc. Through the electrical parameters detected by the switching module 60, it may determine whether the electrical parameters belong to the bone conduction electrical parameter 31 or the air conduction electrical parameter 51. As such, the switching module 60 can generate the corresponding switching data 62 through the bone conduction electrical parameter 31 or the air conduction electrical parameter 51, so as to activate the bone conduction hearing aid module or the air conduction hearing aid module 40 correspondingly.

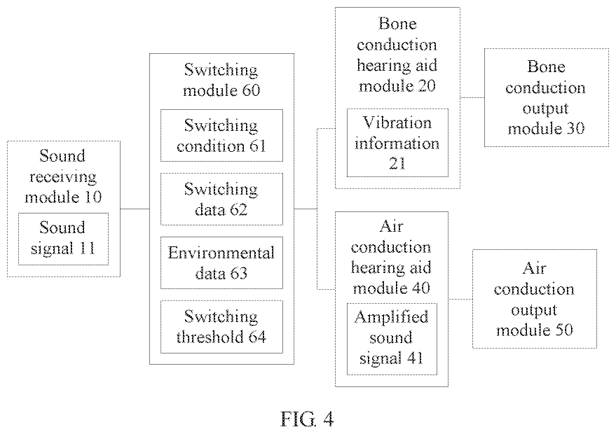

With reference to FIG. 4, illustrating the connections of the bone conduction output module and the air conduction output module according to an example embodiment of the inventive subject matter, the hearing aid switching device can be connected with the bone conduction output module 30 and the air conduction output module 50 at the same time, so as to switch between the bone conduction hearing aid module 20 or the air conduction hearing aid module 40 through the judgment of the switching module 60.

In this way, when the bone conduction hearing aid module 20 is connected with the bone conduction output module 30, and the air conduction hearing aid module 40 is connected with the air conduction output module 50, and the switching module 60 meets the above-mentioned switching condition 61, the switching module 60 then executes the detection program to generate an environmental data 63 correspondingly. The detection program here mainly uses the switching module 60 to receive the sound signal 11 acquired by the sound receiving module 10 (other sound collecting devices can also be used), and execute the detection program on the sound signal 11 to detect an environmental noise in the sound signal 11, and generating the environmental data 63 based on the environmental noise. However, when the sound signal 11 includes the environmental noise and a user sound source, the switching module 60 separates the environmental noise and the user sound source in the sound signal 11 according to a sound feature point data (such as the user's voice feature point data, which can be stored in the switching module or obtained from an external device), so that the switching module 60 generates the environmental data 63 according to the environmental noise.

At this time, the switching module 60 can determine whether to switch according to the environmental data 63 and a switching threshold 64. When the switching module 60 determines that the environmental data 63 is lower than the switching threshold 64 and the bone conduction hearing aid module 20 is in an activated state, or that the environmental data 63 is higher than the switching threshold 64 and the air conduction hearing aid module 40 is in an activated state, the switching module 60 generates the switching data 62, so as to activate the air conduction hearing aid module 40 according to the switching data 62, and turn off the bone conduction hearing aid module 20 (when the environmental data 63 is lower than the switching threshold 64), or activate the bone conduction hearing aid module 20 according to the switching data 62, and turn off the air conduction hearing aid module 40 (when the environmental data 63 is higher than the switching threshold 64).

Since the noise reduction capability of the air conduction hearing aid module 40 is worse than that of the bone conduction hearing aid module 20, the judgment of switching in the above embodiment can be made according to the sound decibels in the environmental noise. That is, when the switching module 60 determines that a sound decibel in the environmental noise is lower than the switching threshold 64 (for example, 70 decibels (dB)) and the bone conduction hearing aid module 20 is in an activated state, the switching module 60 generates the switching data 62 for switching to activate the air conduction hearing aid module 40, so as to activate the air conduction hearing aid module 40 and turn off the bone conduction hearing aid module 20 according to the switching data 62; or when the switching module 60 determines that a sound decibel in the environmental noise is higher than (or equals to) the switching threshold 64 and the air conduction hearing aid module 40 is in an activated state, the switching module 60 generates the switching data 62 for switching to activate the bone conduction hearing aid module 20, so as to activate the bone conduction hearing aid module 20 and turn off the air conduction hearing aid module 40 according to the switching data 62.

The judgment of the above environmental noise can also be replaced with fidelity, comfort or other related factors for adjustments to achieve the above switching function.

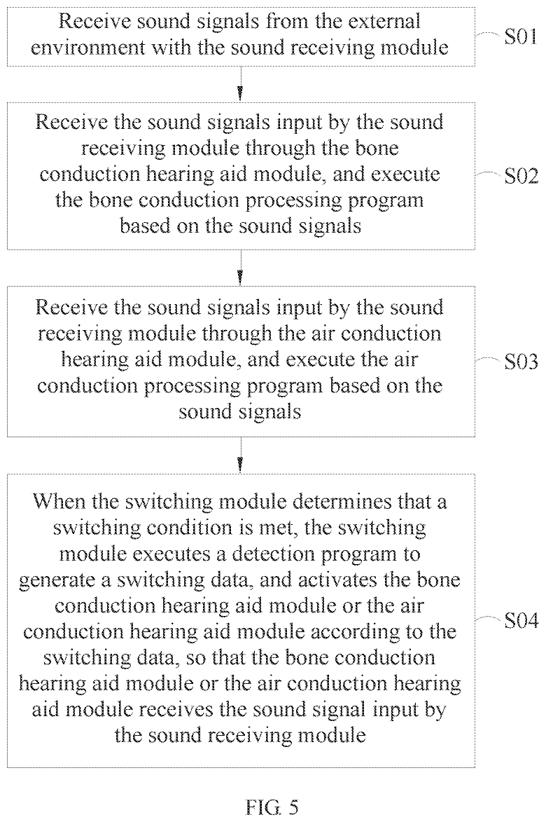

FIG. 5 shows a flowchart of the steps according to an embodiment of the hearing aid switching method of the bone conduction and air conduction hearing aid switching device, which includes:

S01: Receive sound signals from the external environment with the sound receiving module;

S02: Receive the sound signals input by the sound receiving module through the bone conduction hearing aid module, and execute the bone conduction processing program based on the sound signals;

S03: Receive the sound signals input by the sound receiving module through the air conduction hearing aid module, and execute the air conduction processing program based on the sound signals; and

S04: When the switching module determines that a switching condition is met, the switching module executes a detection program to generate a switching data, and activates the bone conduction hearing aid module or the air conduction hearing aid module according to the switching data, so that the bone conduction hearing aid module or the air conduction hearing aid module receives the sound signal input by the sound receiving module.

While the means of specific embodiments in the present disclosure has been described, numerous modifications and variations could be made thereto by those skilled in the art without departing from the scope and spirit of the invention set forth in the claims.

What is claimed is:

1. A bone conduction and air conduction hearing aid switching device, comprising:
a sound receiving module which receives a sound signal from the external environment;
a bone conduction hearing aid module connected to the sound receiving module, the bone conduction hearing aid module receives the sound signal input by the sound receiving module, and the bone conduction hearing aid module executes a bone conduction processing program based on the sound signal;
an air conduction hearing aid module connected to the sound receiving module, the air conduction hearing aid module receives the sound signal input by the sound receiving module, and the air conduction hearing aid module executes an air conduction processing program based on the sound signal; and
a switching module arranged between the sound receiving module and the bone conduction hearing aid module and between the sound receiving module and the air conduction hearing aid module, when the switching module determines that a switching condition is met, the switching module executes a detection program to generate a switching data, and activates the bone conduction hearing aid module or the air conduction hearing aid module according to the switching data, so that the bone conduction hearing aid module or the air conduction hearing aid module receives the sound signal input by the sound receiving module.

2. The bone conduction and air conduction hearing aid switching device of claim 1, further including a bone conduction output module connected to the bone conduction hearing aid module, when the bone conduction hearing aid module executes the bone conduction processing program, the bone conduction hearing aid module generates a vibration information corresponding to a sound wave in the sound signal, and control the bone conduction output module to execute a vibration program according to the vibration information.

3. The bone conduction and air conduction hearing aid switching device of claim 1, further including an air conduction output module connected to the air conduction hearing aid module, when the air conduction hearing aid module executes the air conduction processing program, the air conduction hearing aid module executes an amplification program on the sound signal to generate an amplified sound signal, and outputs the amplified sound signal to the air conduction output module to output the amplified sound signal through the air conduction output module.

4. The bone conduction and air conduction hearing aid switching device of claim 1, wherein the switching module determines whether the switching condition is met includes any one of the following conditions or a combination of any two or more:
when the hearing aid switching device is activated, the switching module determines that the switching condition is met, and when the hearing aid switching device is turned off, the switching module determines that the switching condition is not met;
when the hearing aid switching device is activated, the switching module activates a timing module to calculate a time value, and when the time value calculated by the timing module meets a time switching threshold, the switching module determines that the switching condition is met; or
when the hearing aid switching device detects that the bone conduction hearing aid module is connected to a bone conduction output module or the air conduction hearing aid module is connected to an air conduction output module, the switching module determines that the switching condition is met.

5. The bone conduction and air conduction hearing aid switching device of claim 1, wherein the switching module executes the detection program to generate the switching data includes:
when the bone conduction hearing aid module is connected with a bone conduction output module, the switching module reads a bone conduction electrical parameter of the bone conduction output module, and generates the switching data according to the bone conduction electrical parameter to activate the bone conduction hearing aid module according to the switching data; or
when the air conduction hearing aid module is connected with an air conduction output module, the switching module reads an air conduction electrical parameter of the air conduction output module, and generates the switching data according to the air conduction electrical parameter to activate the air conduction hearing aid module according to the switching data.

6. The bone conduction and air conduction hearing aid switching device of claim 1, wherein when the bone conduction hearing aid module is connected with a bone conduction output module, and the air conduction hearing aid module is connected with an air conduction output module, the switching module executes the detection program to generate an environmental data correspondingly, and when the switching module determines that the environmental data is lower than a switching threshold and the bone conduction hearing aid module is in an activated state, or that the environmental data is higher than the switching threshold and the air conduction hearing aid module is in an activated state, the switching module generates the switching data.

7. The bone conduction and air conduction hearing aid switching device of claim 6, wherein the switching module receives the sound signal, and executes the detection program according to the sound signal to detect an environmental noise in the sound signal, and the switching module generates the environmental data according to the environmental noise.

8. The bone conduction and air conduction hearing aid switching device of claim 7, wherein when the sound signal includes the environmental noise and a user sound source, the switching module separates the environmental noise and the user sound source in the sound signal according to a sound feature point data, so that the switching module generates the environmental data according to the environmental noise.

9. The bone conduction and air conduction hearing aid switching device of claim 7, wherein when the switching module determines that a sound decibel in the environmental noise of the environmental data is lower than the switching threshold and the bone conduction hearing aid module is in an activated state, the switching module generates the switching data for switching to activate the air conduction hearing aid module, so as to activate the air conduction hearing aid module and turn off the bone conduction hearing aid module according to the switching data; or when the switching module determines that a sound decibel in the environmental noise of the environmental data is higher than the switching threshold and the air conduction hearing aid module is in an activated state, the switching module generates the switching data for switching to activate the bone conduction hearing aid module, so as to activate the bone conduction hearing aid module and turn off the air conduction hearing aid module according to the switching data.

10. A bone conduction and air conduction hearing aid switching method for the bone conduction and air conduction hearing aid switching device of claim 1, comprising:
receiving a sound signal from an external environment with a sound receiving module;
receiving the sound signal input by the sound receiving module through a bone conduction hearing aid module, and executing a bone conduction processing program based on the sound signal;
receiving the sound signal input by the sound receiving module through an air conduction hearing aid module, and executing an air conduction processing program based on the sound signal; and
when a switching module determines that a switching condition is met, the switching module executes a detection program to generate a switching data, and activates the bone conduction hearing aid module or the air conduction hearing aid module according to the switching data, so that the bone conduction hearing aid module or the air conduction hearing aid module receives the sound signal input by the sound receiving module.
